(19) United States
(12) Patent Application Publication
(10) Pub. No.: US 2014/0028950 A1
(43) Pub. Date: Jan. 30, 2014

(54) FRAME FOR LIQUID CRYSTAL DISPLAY MODULE

(71) Applicant: Beijing Boe Optoelectronics Technology Co., Ltd., Beijing (CN)

(72) Inventors: Sheng WANG, Beijing (CN); Rui LI, Beijing (CN); Jun LONG, Beijing (CN); Hongkun ZHANG, Beijing (CN)

(21) Appl. No.: 13/942,870

(22) Filed: Jul. 16, 2013

(30) Foreign Application Priority Data
Jul. 25, 2012 (CN) 201220363330.3

(51) Int. Cl. G02F 1/1333

(52) U.S. Cl. CPC G02F 1/133308
USPC 349/58

(57) ABSTRACT

Embodiments of the present invention provide a frame for a liquid crystal display module. The frame includes at least two non-metal separate members, wherein at least one of the separate members is provided with a plurality of mounting grooves, and the separate members is provided with a coupling structure for connecting with each other.

### TECHNICAL FIELD

Embodiments of the present invention relate to a frame for a liquid crystal display module.

### BACKGROUND

Currently, the backlight of the liquid crystal display module needs to be supported and protected by a backboard. Further, a metal frame is required for assembling the backlight or the backboard with a panel. The metal frame and the backboard are made of metal, and thus the cost is high and the manufacturing process needs to be conducted in a special factory.

Besides, the backboard, the metal frame and the backlight are usually assembled together by hooks. It occurs from time to time that the hooks fail to snap properly. In addition, the friction between the hooks and the backboard, the metal frame, and non-metal parts such as the backlight will produce undesirable debris, which in turn affects the quality of the whole liquid crystal display module. Furthermore, the durability and reliability of the above assembled structure is insufficient, and the metal fatigue would affect the lifetime of the whole module. Additionally, because the expansion coefficients of metal and non-metal material, as well as the expansion coefficients of the different metals are different from one another, the liquid crystal display module may fall apart under a high temperature and high humidity environment.

### SUMMARY

One aspect of the present invention relates to a frame for a liquid crystal display module. The frame includes at least two non-metal separate members. At least one separate member of said two separate members is provided with mounting grooves. In addition, the separate members are provided with coupling structures for connecting the separate members with each other.

The other aspect of the present invention relates to a liquid crystal display device, which includes a frame and a liquid crystal display module mounted in said frame.

### BRIEF DESCRIPTION OF THE DRAWINGS

In order to clearly illustrate the technical solution of the embodiments of the invention, the drawings of the embodiments will be briefly described in the following. Apparently, the described drawings are only directed to some embodiments of the invention and thus are not limitative to the present invention.

FIG. 1 is a partial exploded view showing the unitary frame of an embodiment of the present invention;

FIG. 2 is a view showing the separate members of an embodiment of the present invention;

FIG. 3 is an assembly view showing the frame with the liquid crystal display module mounted therein according to another embodiment of the present invention;

FIG. 4 is a partial exploded view showing the unitary frame of another embodiment of the present invention.

### DETAILED DESCRIPTION

For fully understanding of the technical solution of the present invention, the present invention will be further described in details in connection with the drawings and the specific embodiments.

Unless otherwise defined, all the technical and scientific terms used herein have the common meanings as understood by one of ordinary skill in the art to which the present invention belongs. The terms “first” “second” etc., which may be used in the description and the claims of the present invention, are not intended to indicate any sequence, number or importance, but merely to distinguish various components from one another. Also, the terms such as “a” “an” etc., are not intended to limit the number, but indicate the existence of at lease one. The terms “comprise” “comprising” “include,” “including” etc., are intended to specify that the elements or the objects stated before these terms encompass the elements or the objects and equivalents thereof listed after these terms, but do not exclude other elements or objects. The phrases “connect”, “connected”, etc., are not intended to be limited to a physical connection or mechanical connection, but may include an electrical connection, directly or indirectly. “On” “under” “right” “left” and the like are only used to indicate relative position relationship, and when the position of the described object is changed, the relative position relationship may be changed accordingly.

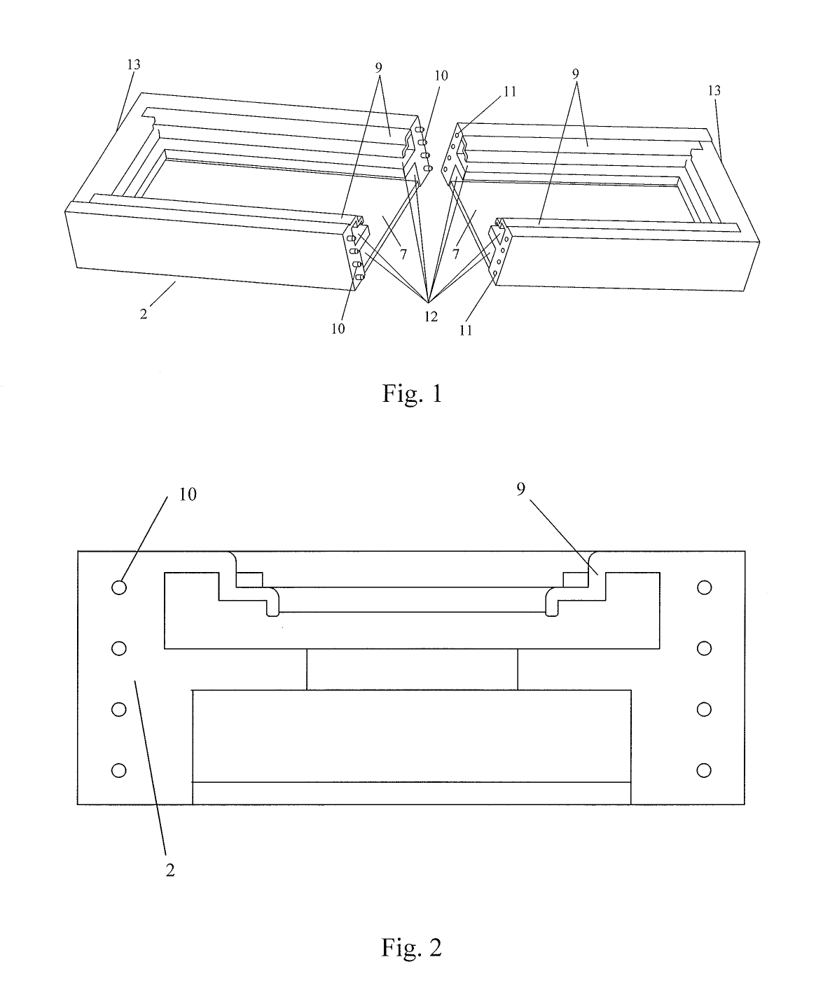

FIG. 1 shows a non-metal frame 2 including two separate members 13. In different embodiments of the present invention, there may be two the separate members 13 configured to be assembled into the non-metal frame 2 as shown in the drawings, or alternatively there may be more than two separate members. The separate members 13 configured to be assembled into the non-metal frame 2 may be connected by the engagement of coupling structures, so as to form a unit, i.e., the non-metal frame 2. In different embodiments of the present invention, the coupling structures may include at least one of a snap-fit structure using grooves and a plug-fit structure. For example, the coupling structure may be a plug-fit structure, e.g. the alignment protrusion(s) 10 and the alignment aperture(s) 11 that can be mated with each other as shown in the drawings.

Although the length of the two separate members 13 shown in FIG. 1 is substantially the same and the width of the two separate members 13 are substantially the same. For example, the two separate members 13 may be symmetrical with respect to the engagement surface of the two separate members. In some embodiments of the present invention, according to certain requirement, the two separate members may be different in length and/or width. For example, the two separate members may be asymmetrical with respect to the engagement surface of the two separate members.

Each of the separate members 13 of the non-metal frame 2 is preferably integrally formed. The materials of different separate members are preferably the same. As such, there will not be any problem resulted from different expansion coefficients in the whole structure formed by the separate members. In some embodiments of the present invention, the separate members 13 may be made from plastic, or industrial rubber. Such materials meet the industry strength requirement, and do not have problems such as a metal fatigue.

The following is described in connection with the embodiment where the coupling structure comprises the alignment protrusions 10 and the alignment apertures 11. Regarding two separate members 13 capable of being engaged with each other, if one of the separate members 13 is provided with alignment protrusion(s) 10, the other separate member 13 may be provided with alignment aperture(s) 11 that is configured to receive corresponding alignment protrusion(s) 10. That is, the two separate members 13 that may be engaged with each other are provided, respectively, with coupling structures capable of being engaged with each other, such that the two separate members 13 can be assembled together. In some embodiments of the present invention, a separate member 13 may be provided with only one type of the coupling structures (e.g. alignment protrusions 10 or alignment apertures 11). In other embodiments of the present invention, a separate member 13 may be provided with more than one type of the coupling structures (e.g. alignment protrusions 10 and alignment apertures 11). The coupling structures may be provided in various ways as long as the separate members 13 can be assembled into a non-metal frame 2.

As to the liquid crystal display module including a backlight, a backboard, and a panel, the non-metal frame 2 is provided with mounting grooves 12 for retaining the liquid crystal display module. Different mounting grooves 12 may retain different elements of the liquid crystal display module. Besides, the mounting grooves are provided layer by layer in the separate members 13. The depth and number of the mounting grooves 12 may be varied according to the actual application circumstances. For example, the depths of the mounting grooves 12 at all different layers may be the same or may be different, or the depths of some of the mounting grooves 12 may be the same.

In addition, the undersides (e.g. the bottoms) of the separate members 13 may be provided with supporting structures 7 for supporting the liquid crystal display module. Further, the upper sides (e.g. the tops, the rims) of the separate members 13 are provided with light shielding ribs 9 for shielding the clearances between the panel in the separate members 13 and the rims of the separate members 13 to avoid light leakage.

During assembling, each element of the liquid crystal display module may be received in corresponding mounting grooves 12 of the separate members 13 of the non-metal frame 2 respectively. Then, the coupling structure of each separate member 13 is used to assemble the separate members 13 into a unit, i.e., the non-metal frame 2 with the liquid crystal display module mounted therein. For instance, the two (or more than two) separate members 13 are assembled into a non-metal frame 2 by the engagement of the alignment protrusions 10 with the alignment apertures 11.

Additionally, adhesive may be applied to each separate member 13 at engagement positions for firmly attaching the separate members 13 together and forming the non-metal frame 2.

It should be noted that if one or more of the separate members 13 configured to be assembled into the non-metal frame 2 is provided with mounting grooves 12 and said mounting grooves can properly receive the liquid crystal display module, others of the separate members 13 may not need to be provided with any mounting groove 12. That is, at least one of the separate members 13 configured to be assembled into the non-metal frame 2 is provided with mounting grooves 12 to ensure a proper installation of the liquid crystal display module.

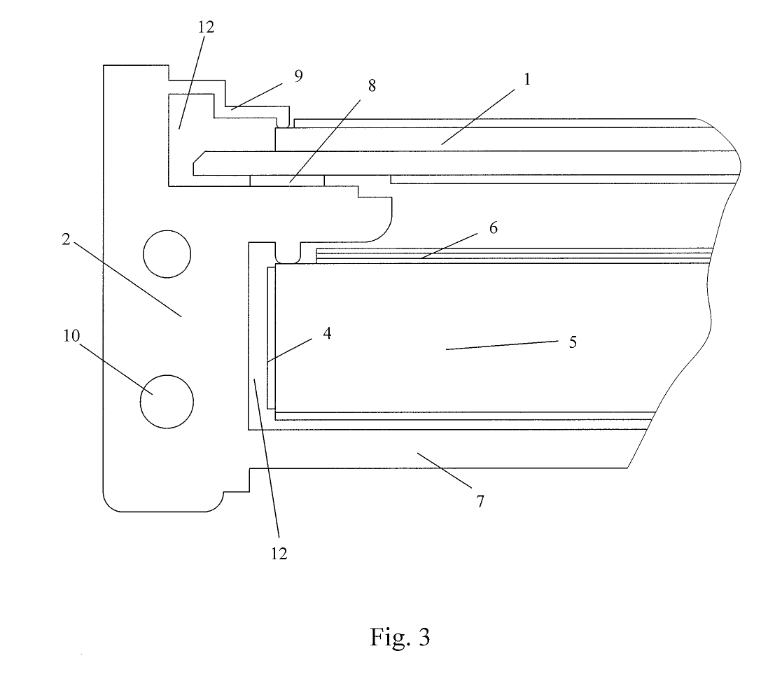

The separate members 13 shown in FIG. 1 may be assembled into the non-metal frame 2. The non-metal frame 2 with the liquid crystal display module mounted therein is shown in FIG. 3. In FIG. 3, the liquid crystal display module is mounted in the separate members 13 of the non-metal frame 2 to produce a liquid display device. According to practical application circumstances, the liquid crystal display module may comprise various elements, such as: a panel 1, reflecting films 4, a light guiding plate 5, optical films 6 and so on. The reflecting films 4 and the light guiding plate 5 can form a backlight module disposed under the panel 1. The optical films 6 such as anti-reflection films and prism films are placed on the light guiding plate 1 for improving the uniformity of the light emitted from the light guiding plate 1. The configuration of the liquid crystal display module of the liquid crystal display device according to the embodiment of the present invention is not limited to that shown in FIG. 3, and may be changed as desired.

As shown in FIG. 3, gaskets 8 may be positioned between the panel 1 and the separate members 13, and the light shielding ribs 9 positioned above the separate members 13 can cover the clearances between the panel 1 and the rims of the separate members 13, so as to avoid light leakage.

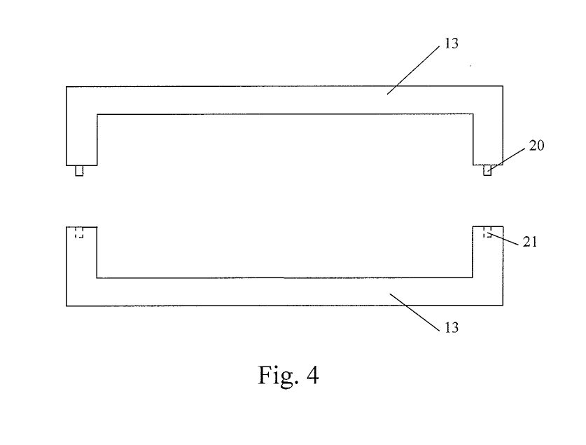

The separate members 13 shown in FIG. 1 are a left member and a right member that may be separated in the length direction (the left-right direction as shown in FIG. 1). In the other embodiments of the present invention, the separate members 13 may be separated in other manner. For example, the separate members 13 shown in FIG. 4 are a front member and a rear member that may be separated in the width direction (the up-down direction as shown in FIGS. 1 and 4) (for simplicity, the light shielding ribs 9, the mounting grooves 12 and so on are not shown in FIG. 4). Although the lengths and widths of the two separate members 13 in FIG. 4 are substantially the same, that is, the two separate members 13 are symmetry with respect to the engagement surface of the two separate members. In some embodiments of the present invention, according to practical requirements, the two separate members have different lengths and/or widths. For example, the two separate members are asymmetric with respect to the engagement surface of the two separate members. In some embodiments of the present invention, the separate members 13 can be further separated in the width direction or in other manner in addition to the separation in the length direction.

In the embodiment shown in FIG. 4, the coupling structures are snap-fit structures that may include snapping grooves 21 and/or snapping protrusions 20 adapted to engage with each other. For instance, one of the two separate members 13 adapted to be engaged together is provided with snapping grooves 21, while the other of separate members 13 is provided with snapping protrusions 20, so that a unitary frame, i.e. the non-metal frame 2 may be formed by the engagement (e.g. snap-fit) of the snapping grooves 21 and the snapping protrusions 20. In some embodiments of the present invention, the coupling structures may be other structures that can be used to couple the separate members 13 into a non-metal frame 2.

By way of example, the display device of the embodiments of the present invention may be used in a liquid crystal television, a mobile phone, a GPS, a digital photo frame, a game machine etc.

In connection with the above description, it should be understood that the unitary non-metal frame for retaining the liquid crystal display module of the present invention has improved stability and reliability, and has largely reduced cost because there is no need for a metal backboard and metal frame. In addition, the separate members can be assembled easily by using said coupling structures, and therefore the present invention has the advantages of reduced assemble time, and has wide application.

The invention is thus described in connection with exemplary embodiments for illustrating the principle of the present invention, and not for limiting. It is obvious to those skilled in the art that the present invention may have various variations or modifications without departing from the spirit and essence of the present invention, and all such variations or modifications as would be obvious to those skilled in the art are intended to be within the scope of the following claims.

1. A frame for a liquid crystal display module, including at least two non-metal separate members adapted to be assembled into the frame;
wherein at least one of the separate members is provided with a plurality of mounting grooves; and the separate members is provided with coupling structures for connecting the separate members with each other .

2. The frame of claim 1, wherein, comprising two separate members, one of the two separate members is the same as the other separate member in length and width.

3. The frame of claim 1, comprising two separate members, at least one of the length and width of one of the two separate members is different from that of the other separate member.

4. The frame of claim 1, wherein the separate members can be separated in length direction or width direction.

5. The frame of claim 1, wherein, the coupling structures include at least one of a plug-fit structure or a snap-fit structure.

6. The frame of claim 5, wherein,
the plug-fit structure includes one or more alignment protrusion and one or more alignment aperture adapted to receive the alignment protrusion.

7. The frame of claim 5, wherein,
the snap-fit structure includes one or more snapping groove and one or more snapping protrusion adapted to be snapped into the snapping groove.

8. The frame of claim 1, wherein,
said plurality of mounting grooves are provided layer-by-layer in the separate members.

9. The frame of claim 1, wherein,
the separate members are provided with supporting structures for supporting the liquid crystal display module.

10. The frame of claim 9, wherein each of said separate members is provided with a light shielding rib for covering a clearance between the separate member and a panel of the liquid crystal display module.

11. The frame of claim 1, wherein, the separate members are made of plastic or rubber.

12. The frame of claim 1, wherein, the separate member is integrally formed.

13. A liquid crystal display device, including the frame of claim 1 and a liquid crystal display module mounted in said frame.
